(19) United States
(12) Patent Application Publication
(10) Pub. No.: US 2016/0094770 A1
(43) Pub. Date: Mar. 31, 2016

(54) Image Processing Method and Apparatus, and Terminal

(71) Applicant: Huawei Device Co., Ltd., Shenzhen (CN)

(72) Inventor: Lei Chen, Beijing (CN)

(21) Appl. No.: 14/964,757

(22) Filed: Dec. 10, 2015

Related U.S. Application Data
(63) Continuation of application No. PCT/CN2014/081787, filed on Jul. 8, 2014.

(30) Foreign Application Priority Data
Jul. 8, 2013 (CN) 201310284374.6

(51) Int. Cl. H04N 5/235

(52) U.S. Cl. CPC H04N 5/2354; H04N 5/2353

(57) ABSTRACT

An image processing method and apparatus, and a terminal, that relate to the field of data processing, so that a photographed image can be clearer, thereby effectively improving image processing efficiency. The method includes acquiring luminance of a current photographing environment and a photographing moving speed of a target object; determining an exposure parameter and a gain parameter according to the luminance of the current photographing environment and the photographing moving speed of the target object; and processing an acquired image of the target object according to the exposure parameter and the gain parameter. The present disclosure is applicable to data processing technologies.

### CROSS-REFERENCE TO RELATED APPLICATIONS

This application is a continuation of International Application No. PCT/CN2014/081787, filed on Jul. 8, 2014, which claims priority to Chinese Patent Application No. 201310284374.6, filed on Jul. 8, 2013, both of which are hereby incorporated by reference in their entireties.

### TECHNICAL FIELD

The present disclosure relates to the field of data processing, and in particular, to an image processing method and apparatus, and a terminal.

### BACKGROUND

Current terminals such as a mobile phone and a tablet computer are all equipped with cameras, and a user may take a photograph anytime and anywhere using a terminal.

However, due to a size limit, a terminal such as a mobile phone is equipped with a camera having a small aperture, and cannot maintain sufficient exposure when a very short shutter speed (an exposure time) is set. In this way, when a moving object is photographed using a terminal, obvious visual shadow and streaking phenomena generally occur, so that a photographed image is very unclear, thereby reducing image processing efficiency.

### SUMMARY

Embodiments of the present disclosure provide an image processing method and apparatus, and a terminal, so that a photographed image can be clearer, thereby effectively improving image processing efficiency.

According to a first aspect, an embodiment of the present disclosure provides an image processing method, where the method includes acquiring luminance of a current photographing environment and a photographing moving speed of a target object; determining an exposure parameter and a gain parameter according to the luminance of the current photographing environment and the photographing moving speed of the target object; and processing an acquired image of the target object according to the exposure parameter and the gain parameter.

In a first possible implementation manner of the first aspect, when the target object moves and an image processing apparatus keeps motionless, the acquiring a photographing moving speed of the target object includes acquiring a distance that the target object moves between images of two adjacent frames; acquiring a time interval between the images of two adjacent frames; and acquiring the photographing moving speed of the target object according to the distance that the target object moves and the time interval.

With reference to the first possible implementation manner of the first aspect, in a second possible implementation manner of the first aspect, the acquiring a distance that the target object moves between images of two adjacent frames includes determining at least one key information point in a shot range; acquiring a location of the key information point in each of the images of two adjacent frames; and determining, according to the location of the key information point in each of the images of two adjacent frames, the distance that the target object moves between the images of two adjacent frames.

In a third possible implementation manner of the first aspect, when the target object keeps motionless and an image processing apparatus is in a moving state, a moving speed of the apparatus is used as the photographing moving speed of the target object.

In a fourth possible implementation manner of the first aspect, when the target object and an image processing apparatus are both in a moving state and moving speeds of the target object and the image processing apparatus are inconsistent, the acquiring a photographing moving speed of the target object includes acquiring a distance that the target object moves between images of two adjacent frames, acquiring a time interval between the images of two adjacent frames, and acquiring the photographing moving speed of the target object according to the distance that the target object moves and the time interval; and when the target object and the image processing apparatus are both in the moving state and the moving speeds of the target object and the image processing apparatus are consistent, the acquired photographing moving speed of the target object is zero.

In a fifth possible implementation manner of the first aspect, the determining an exposure parameter and a gain parameter according to the luminance of the current photographing environment and the photographing moving speed of the target object includes determining, according to the luminance of the current photographing environment and the photographing moving speed of the target object, the exposure parameter by searching a preset exposure parameter table; and determining the gain parameter according to the exposure parameter.

With reference to the first possible implementation manner or the second possible implementation manner of the first aspect, in a sixth possible implementation manner of the first aspect, the method further includes performing smoothing processing on the photographing moving speed.

According to a second aspect, an embodiment of the present disclosure provides an image processing apparatus, where the apparatus includes an acquiring unit configured to acquire luminance of a current photographing environment and a photographing moving speed of a target object; a determining unit configured to determine an exposure parameter and a gain parameter according to the luminance of the current photographing environment and the photographing moving speed of the target object that are acquired by the acquiring unit; and a processing unit configured to process an acquired image of the target object according to the exposure parameter and the gain parameter that are determined by the determining unit.

In a first possible implementation manner of the second aspect, when the target object moves and the image processing apparatus keeps motionless, the acquiring unit includes a first acquiring module configured to acquire a distance that the target object moves between images of two adjacent frames; a second acquiring module configured to acquire a time interval between the images of two adjacent frames; and a third acquiring module configured to acquire the photographing moving speed of the target object according to the distance that the target object moves and the time interval.

With reference to the first possible implementation manner of the second aspect, in a second possible implementation manner of the second aspect, the first acquiring module is configured to determine at least one key information point in a shot range; acquire a location of the key information point in each of the images of two adjacent frames; and determine, according to the location of the key information point in each of the images of two adjacent frames, the distance that the target object moves between the images of two adjacent frames.

In a third possible implementation manner of the second aspect, when the target object keeps motionless and the image processing apparatus is in a moving state, the acquiring unit uses a moving speed of the apparatus as the photographing moving speed of the target object.

In a fourth possible implementation manner of the second aspect, when the target object and the image processing apparatus are both in a moving state and moving speeds of the target object and the image processing apparatus are inconsistent, a first acquiring module is further configured to acquire a distance that the target object moves between images of two adjacent frames, the second acquiring module is further configured to acquire a time interval between the images of two adjacent frames, and the third acquiring module is further configured to acquire the photographing moving speed of the target object according to the distance that the target object moves and the time interval; and when the target object and the image processing apparatus are both in the moving state, and the moving speeds of the target object and the image processing apparatus are consistent, the photographing moving speed, which is acquired by the third acquiring module, of the target object is zero.

In a fifth possible implementation manner of the second aspect, the determining unit includes a first parameter determining module configured to determine, according to the luminance of the current photographing environment and the photographing moving speed of the target object, the exposure parameter by searching a preset exposure parameter table; and a second parameter determining module configured to determine the gain parameter according to the exposure parameter.

With reference to the first possible implementation manner of the second aspect or the second possible implementation manner of the second aspect, in a sixth possible implementation manner of the second aspect, the processing unit is further configured to perform smoothing processing on the photographing moving speed.

According to a third aspect, an embodiment of the present disclosure provides a terminal, where the terminal includes the image processing apparatus according to the second aspect or any one implementation manner of the possible implementation manners of the second aspect.

According to the image processing method and apparatus, and the terminal that are provided in the embodiments of the present disclosure, first, luminance of a current photographing environment and a photographing moving speed of a target object are acquired; next, an exposure parameter and a gain parameter are determined according to the luminance of the current photographing environment and the photographing moving speed of the target object; and then, an acquired image of the target object is processed according to the determined exposure parameter and gain parameter. It can be seen from the foregoing that, in such a manner in which an exposure parameter and a gain parameter may be determined using luminance of a current photographing environment and a photographing moving speed of a target object, a case in which a visual shadow or streaking appears in a photographed image when a photographed target object is a moving object is avoided, so that the photographed image is clearer, thereby effectively improving image processing efficiency.

### BRIEF DESCRIPTION OF DRAWINGS

To describe the technical solutions in the embodiments of the present disclosure more clearly, the following briefly introduces the accompanying drawings required for describing the embodiments. The accompanying drawings in the following description show merely some embodiments of the present disclosure, and a person of ordinary skill in the art may still derive other drawings from these accompanying drawings without creative efforts.

FIG. 1 is a schematic flowchart of an image processing method according to Embodiment 1 of the present disclosure;

FIG. 2 is a schematic diagram of a table of the image processing method according to Embodiment 1 of the present disclosure;

FIG. 3 is a schematic structural diagram of an image processing apparatus according to Embodiment 2 of the present disclosure;

FIG. 4 is another schematic structural diagram of the image processing apparatus according to Embodiment 2 of the present disclosure;

FIG. 5 is still another schematic structural diagram of the image processing apparatus according to Embodiment 2 of the present disclosure;

FIG. 6 is a schematic structural diagram of an image processing apparatus according to Embodiment 3 of the present disclosure; and

FIG. 7 is a schematic flowchart of an image processing method according to Embodiment 4 of the present disclosure.

### DESCRIPTION OF EMBODIMENTS

The following clearly describes the technical solutions in the embodiments of the present disclosure with reference to the accompanying drawings in the embodiments of the present disclosure. The described embodiments are merely some but not all of the embodiments of the present disclosure. All other embodiments obtained by a person of ordinary skill in the art based on the embodiments of the present disclosure without creative efforts shall fall within the protection scope of the present disclosure.

### Embodiment 1

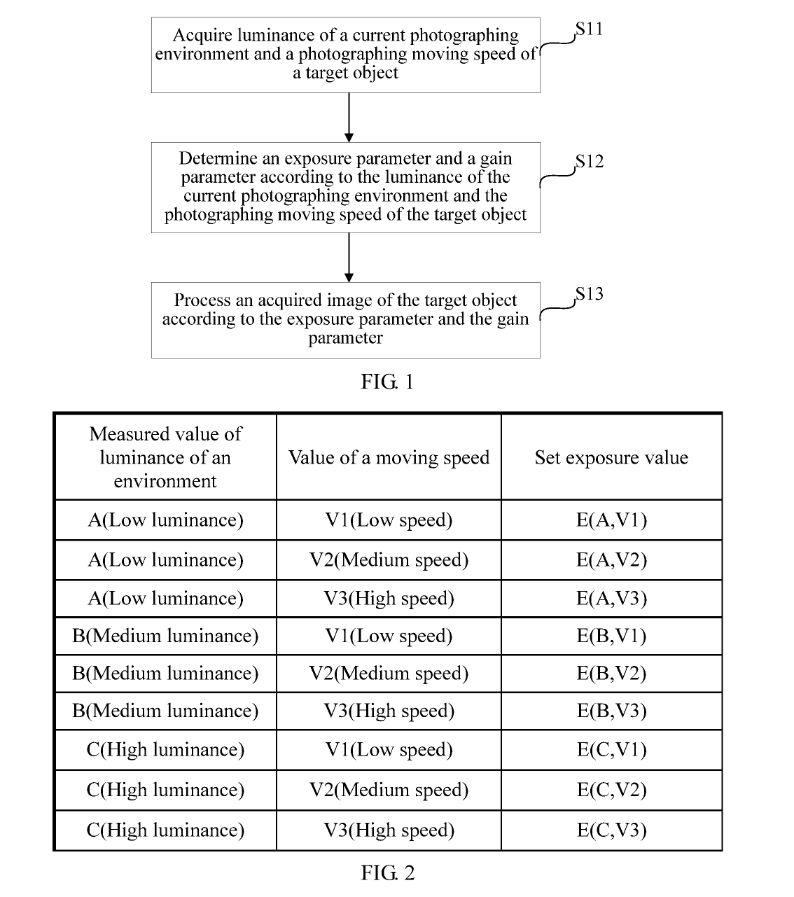

Embodiment 1 of the present disclosure provides an image processing method. The method is executed by a terminal and is specifically executed by an image processing apparatus installed in the terminal. As shown in FIG. 1, the method includes the following steps:

S11. Acquire luminance of a current photographing environment and a photographing moving speed of a target object.

In this step, the target object refers to one or more persons, animals, scenes, or the like in a shot range of the image processing apparatus. The photographing moving speed of the target object refers to a moving speed of a photographed target object relative to the image processing apparatus. It should be noted that the image processing apparatus may be configured to acquire all images in the shot range, and certainly, all the images include an image of the target object. The image processing apparatus may include components such as a camera, a light sensor, and an image processor.

According to different states of the image processing apparatus and the target object, the following three cases may be classified:

In a first case, the target object is in a moving state, and the image processing apparatus keeps in a motionless state; in a second case, the target object keeps in a motionless state, and the image processing apparatus is in a moving state; and in a third case, the target object and the image processing apparatus are both in a moving state.

It should be noted that, in this embodiment of the present disclosure, states of the target object and the image processing apparatus in the foregoing three cases are relative to the ground.

Specific implementation processes of acquiring the photographing moving speed of the target object in the foregoing three cases are as follows:

In the first case, when the target object is in the moving state and the image processing apparatus keeps in the motionless state, acquiring the photographing moving speed of the target object may include the following process:

11. Acquire a distance that the target object moves between images of two adjacent frames.

12. Acquire a time interval between the images of two adjacent frames.

13. Acquire the photographing moving speed of the target object between the images of two adjacent frames according to the distance that the target object moves and the time interval.

A specific process of acquiring the distance that the target object moves between the images of two adjacent frames in step 11 may be:

111. Determine at least one key information point in a shot range.

In this embodiment of the present disclosure, a red green blue (RGB) color standard may be used in the image processing apparatus. According to an RGB principle, three primary colors of red, green, and blue may be mixed according to different proportions to generate millions of colors, and in an RGB mode, each pixel in an image can be allocated an intensity value ranging from 0 to 255. Because each pixel in an image is allocated a different color and intensity, a color and luminance of an information point in the shot range differs from that of a surrounding environment, so that the information point may be determined as a key information point. For example, the key information point may be a flower on a green meadow, black hairs of a person, a facial feature, or the like.

112. Acquire a location of the key information point in each of the images of two adjacent frames; and determine, according to the location of the key information point in each of the images of two adjacent frames, the distance that the target object moves between the images of two adjacent frames.

In a specific embodiment of the present disclosure, step 112 may further be divided into the following two steps:

1121. Determine the at least one key information point in an image of a first frame, and for an image of a second frame or an image after a second frame, a key information point the same as that of the image of the first frame may be taken for analysis.

For example, two key information points are determined in the image of the first frame, where it may be determined that a quantity of key information points on the target object is one, and it may be determined that a quantity of key information points in a surrounding area is one.

1122. Determine locations of the two key information points in the images of two adjacent frames; and determine, according to the locations of the key information points in each of the images of two adjacent frames, the distance that the target object moves between the images of two adjacent frames.

A coordinate axis method may be used for determining the distance that the target object moves between the images of two adjacent frames. For example, in the image of the first frame, coordinates of a key information point a of the target object are (0, 4), and coordinates of a key information point b in the surrounding area are (2, 6); and in the image of the second frame, coordinates of the key information point a are (3, 8), and coordinates of the key information point b are still (2, 6). Because values of the coordinates of the key information point b keep unchanged, the surrounding area represented by the key information point b does not move, so that it may be obtained that the distance that the target object moves is 5.

In this step, the time interval between the images of two adjacent frames is set by the image processing apparatus according to the luminance of the current photographing environment. In a preview stage before photographing, when luminance of a photographing environment is low, an exposure time required by an image of each frame needs to be increased accordingly. The image processing apparatus adjusts an image output frame rate in real time according to a current exposure time, so that the image output frame rate is reduced, that is, the time interval between the images of two adjacent frames is increased; otherwise, when the luminance of the photographing environment is high, the exposure time needs to be shortened accordingly, so that the image output frame rate is improved, that is, the time interval between the images of two adjacent frames is shortened.

In the second case, when the target object keeps in the motionless state and the image processing apparatus is in the moving state, a moving speed of the apparatus is used as the photographing moving speed of the target object.

When distances that all or most key information points move between the images of two adjacent frames are the same, it may be determined that the target object keeps in the motionless state.

In this case, the moving speed of the apparatus is easy to be acquired in the prior art, for example, the moving speed of the apparatus may be directly measured, and in this way, the acquired moving speed of the apparatus is the photographing moving speed of the target object. How to acquire the photographing moving speed of the target object is not specifically limited in the present disclosure.

In the third case, when the target object and the image processing apparatus are both in the moving state and moving speeds of the target object and the image processing apparatus are inconsistent, a relative moving speed between the target object and the image processing apparatus is used as the photographing moving speed of the target object.

In this case, acquiring the photographing moving speed of the target object includes acquiring a distance that the target object moves between images of two adjacent frames; acquiring a time interval between the images of two adjacent frames; and acquiring the photographing moving speed of the target object according to the distance that the target object moves and the time interval.

Certainly, when the target object and the image processing apparatus are both in the moving state and the moving speeds of the target object and the image processing apparatus are consistent, the distance that the target object moves between the images of two adjacent frames is zero because the relative moving speed between the target object and the apparatus is zero, so that the photographing moving speed of the target object is zero.

In addition, in order to enhance smoothness and accuracy of an operation result of the photographing moving speed, before photographing, corresponding smoothing processing may further be performed on results, which are obtained by means of measurement and calculation, of photographing moving speeds of the target object between images of multiple adjacent frames, so that a more accurate photographing moving speed of the target object is obtained during the photographing.

There are multiple methods for performing smoothing processing on data, for example, a speed smoothing formula may be selected for calculation. The smoothing processing may be performed on the results of the moving speeds according to the following speed smoothing formula:

the speed smoothing formula:

Vc=a*Vo+(1-a)*Vnow; and

Vo=Vc,

where, Vc is a moving speed obtained after smoothing, Vo is a moving speed calculated last time and obtained after smoothing, Vnow is a moving speed calculated currently, and a is a proportional coefficient, where a value range of a is (0, 1).

For example, a value of a may be 0.5, and in this way, Vnow obtained by means of current calculation accounts for only 50 percent (%) of finally used Vc. For example, a previous speed is 100, and Vnow is 200 due to a certain reason (for example, a possible calculation error); however, an actual speed may be only 120. After processing is performed using the smoothing formula, a value of Vc obtained by means of calculation is 150, that is, a peak value that Vnow may reach is smoothed to some extent, thereby reducing an error between Vnow and an actual moving speed.

S12. Determine an exposure parameter and a gain parameter according to the luminance of the current photographing environment and the photographing moving speed of the target object.

In this embodiment of the present disclosure, the exposure parameter is a numerical value representing definition of a photographed image, and the gain parameter is a numerical value representing luminance of a photographed image. A numerical value of the exposure parameter and a numerical value of the gain parameter may be determined according to a value of the acquired luminance of the current photographing environment and a value of the acquired photographing moving speed. The exposure parameter in this embodiment of the present disclosure refers to an exposure time.

How the photographing moving speed affects the exposure parameter and the gain parameter is described in the following. In this embodiment of the present disclosure, in a case in which the luminance of the current photographing environment keeps unchanged, a faster photographing moving speed of the target object indicates a shorter set exposure time. However, shortening of the exposure time indicates that luminance of a photographed image is reduced, and to ensure the luminance of the photographed image, the gain parameter needs to be increased.

It should be noted that in this embodiment of the present disclosure, an exposure parameter table may be established, where the luminance of the current photographing environment and the photographing moving speed of the target object are used as input parameters of the exposure parameter table, and the exposure parameter is used as an output parameter of the exposure parameter table. As shown in FIG. 2, A, B, and C represent values of the luminance of the current photographing environment, V1, V2, and V3 represent values of the moving speed, and E represents a value of the exposure parameter. When the moving speed is not zero, a calculation relationship among the three may be calculated using a formula (M* luminance/speed), where M is a constant, and may also be slightly adjusted based on this calculated value according to an actual condition. In conclusion, the value of the exposure parameter is inversely proportional to that of the moving speed, and is proportional to that of the luminance of the current photographing environment. Certainly, the foregoing table is only used as an example in this embodiment of the present disclosure. In an actual application, the luminance and the speed, for example, both may be classified into more levels, which is not limited in the present disclosure.

In this way, the exposure parameter may be acquired according to the luminance of the current photographing environment and the photographing moving speed of the target object by searching the exposure parameter table. Because a certain value is obtained by multiplying the exposure parameter by the gain parameter, the gain parameter may be obtained according to the exposure parameter.

It should be noted that a numerical value in the exposure parameter table may be preset, so that when a user photographs a target object, the user may find a corresponding exposure parameter directly in the preset exposure parameter table according to luminance of a current environment and a photographing moving speed of the target object.

S13. Process an acquired image of the target object according to the exposure parameter and the gain parameter.

In this step, content of processing the image includes image collection and luminance processing after the collection. Processes of the collection and the luminance processing are the same as those in the prior art, and details are not described herein. After the image is processed, the processed image further needs to be compressed and stored. Processes of compressing and storing the image are the same as those in the prior art, and details are not described herein.

According to the image processing method in this embodiment of the present disclosure, first, luminance of a current photographing environment and a photographing moving speed of a target object are acquired; next, an exposure parameter and a gain parameter are determined according to the luminance of the current photographing environment and the photographing moving speed of the target object; and then, an acquired image of the target object is processed according to the determined exposure parameter and gain parameter. It can be seen from the foregoing that, in such a manner in which an exposure parameter and a gain parameter may be determined using luminance of a current photographing environment and a photographing moving speed of a target object, a case in which a visual shadow or streaking appears in a photographed image when a photographed target object is a moving object is avoided, so that the photographed image is clearer, thereby effectively improving image processing efficiency.

### Embodiment 2

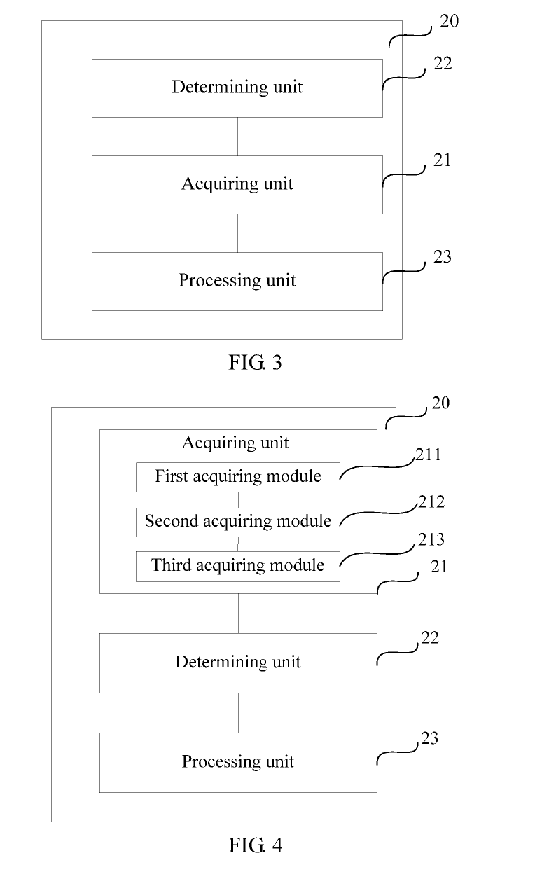

Correspondingly, Embodiment 2 of the present disclosure further provides an image processing apparatus 20. As shown in FIG. 3, the apparatus 20 includes an acquiring unit 21 configured to acquire luminance of a current photographing environment and a photographing moving speed of a target object; a determining unit 22 configured to determine an exposure parameter and a gain parameter according to the luminance of the current photographing environment and the moving speed of the target object that are acquired by the acquiring unit 21; and a processing unit 23 configured to process an acquired image of the target object according to the exposure parameter and the gain parameter that are determined by the determining unit 22.

According to the image processing apparatus 20 in this embodiment of the present disclosure, first, the determining unit 22 determines the exposure parameter and the gain parameter according to the luminance of the current photographing environment and the photographing moving speed of the target object that are acquired by the acquiring unit 21; and then, the processing unit 23 processes the acquired image of the target object according to the exposure parameter and the gain parameter that are determined by the determining unit 22. It can be seen from the foregoing that, this apparatus may determine the exposure parameter and the gain parameter according to the luminance of the current photographing environment and the photographing moving speed of the target object, which avoids a case in which a visual shadow or streaking appears in a photographed image when a photographed target object is a moving object, so that the photographed image is clearer, thereby effectively improving image processing efficiency.

Optionally, in an embodiment of the present disclosure, when the target object moves and the image processing apparatus keeps motionless, as shown in FIG. 4, the acquiring unit 21 includes a first acquiring module 211 configured to acquire a distance that the target object moves between images of two adjacent frames; a second acquiring module 212 configured to acquire a time interval between the images of two adjacent frames; and a third acquiring module 213 configured to acquire the photographing moving speed of the target object according to the distance that the target object moves and the time interval.

Further, in an embodiment of the present disclosure, the first acquiring module 211 is configured to determine at least one key information point in a shot range; acquire a location of the key information point in each of the images of two adjacent frames; and determine, according to the location of the key information point in each of the images of two adjacent frames, the distance that the target object moves between the images of two adjacent frames.

Further, in an embodiment of the present disclosure, the processing unit 23 is further configured to perform smoothing processing on the photographing moving speed. This processing manner can enhance smoothness and accuracy of an operation result of the photographing moving speed.

Optionally, in an embodiment of the present disclosure, when the target object keeps motionless and the image processing apparatus moves, the acquiring unit 21 uses a moving speed of the image processing apparatus as the photographing moving speed of the target object.

Optionally, in an embodiment of the present disclosure, when the target object and the image processing apparatus are both in a moving state and moving speeds of the target object and the image processing apparatus are inconsistent, the first acquiring module 211 is further configured to acquire a distance that the target object moves between images of two adjacent frames; the second acquiring module 212 is further configured to acquire a time interval between the images of two adjacent frames; and the third acquiring module 213 is further configured to acquire the photographing moving speed of the target object according to the distance that the target object moves and the time interval.

When the target object and the image processing apparatus are both in the moving state and the moving speeds of the target object and the image processing apparatus are consistent, because a relative moving speed between the target object and the apparatus is zero, the distance that the target object moves between the images of two adjacent frames and is acquired by the first acquiring module 211 is zero, so that the photographing moving speed, which is acquired by the third acquiring module 213, of the target object is zero.

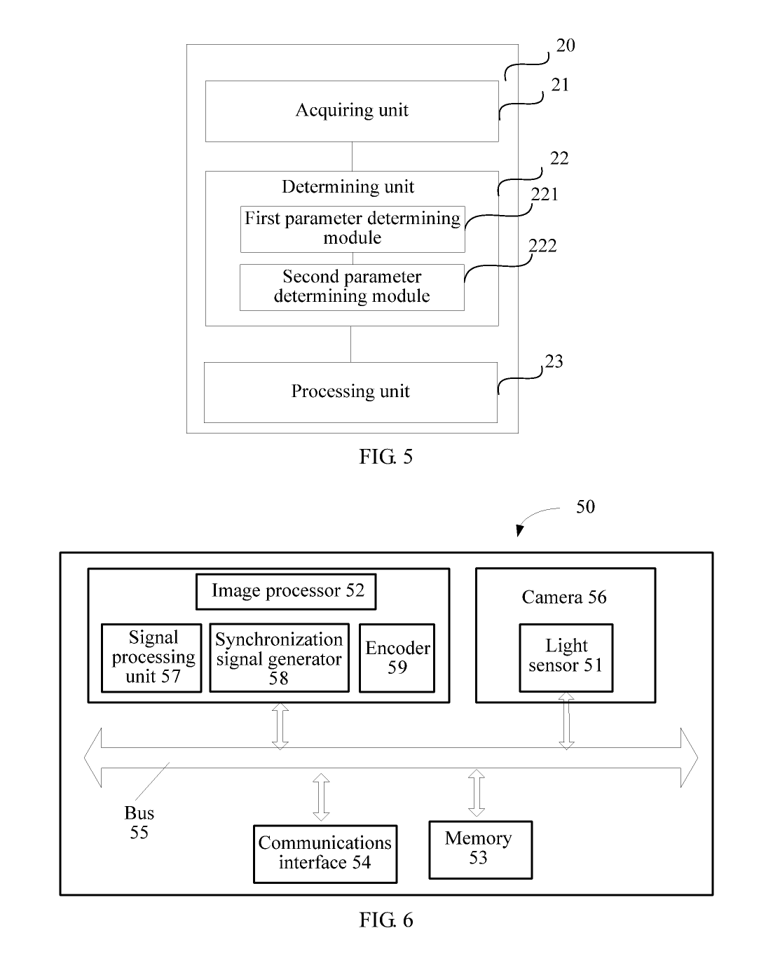

Optionally, in an embodiment of the present disclosure, as shown in FIG. 5, the determining unit 22 includes a first parameter determining module 221 configured to determine, according to the luminance of the current photographing environment and the photographing moving speed of the target object, the exposure parameter by searching a preset exposure parameter table; and a second parameter determining module 222 configured to determine the gain parameter according to the exposure parameter.

It should be noted that, for specific functions of structural units of the image processing apparatus 20 provided in this embodiment of the present disclosure, refer to the foregoing method embodiment.

### Embodiment 3

FIG. 6 shows another embodiment of an image processing apparatus according to the present disclosure. It should be understood that an image processing apparatus 50 shown in the figure is only an example of the image processing apparatus, and the image processing apparatus 50 may have more or fewer components than those shown in the figure, may combine two or more components or may have different component configurations. Various components shown in the figure may be implemented by hardware including one or more signal processing and/or application specific integrated circuits, software, or a combination of software and hardware.

As shown in FIG. 6, the image processing apparatus 50 provided in this embodiment includes a light sensor 51, an image processor 52, a memory 53, a communications interface 54, a bus 55, and a camera 56. The light sensor 51 is disposed in the camera 56. The light sensor 51, the image processor 52, the memory 53, and the communications interface 54 are connected using the bus 55 to complete communication. The bus 55 may be an industry standard architecture (ISA) bus, a peripheral component interconnect (PCI) bus, or an extended industry standard architecture (EISA) bus, or the like. The bus 55 may be classified into an address bus, a data bus, a control bus, or the like. For ease of representation, the bus 55 is represented using only a bold line in FIG. 6, but it does not indicate that there is only one bus or one type of buses.

The memory 53 is configured to store executable program code, and the program code includes a computer operation instruction. The memory 53 may include a high-speed random access memory (RAM), or may include a non-volatile memory, for example, one or more magnetic disk storage devices, a flash memory, or another volatile solid-state storage device. The memory 53 may be accessed by the image processor 52, the communications interface 54, and the like.

The light sensor 51 is configured to acquire luminance of a current photographing environment. The light sensor 51 is configured to covert ambient light into an electrical signal; and the electrical signal is compressed and then is saved by the memory 53.

The image processor 52 includes a signal processing unit 57, a synchronization signal generator 58, an encoder 59, and the like, so as to acquire a photographing moving speed of a target object; determine an exposure parameter and a gain parameter according to the photographing moving speed of the target object and the luminance of the current photographing environment that is acquired by the light sensor 51; and process an image, which is acquired by the camera 56, of the target object.

Optionally, in an embodiment of the present disclosure, when the target object moves and the image processing apparatus 50 keeps motionless, the image processor 52 is configured to acquire a distance that the target object moves between images of two adjacent frames; acquire a time interval between the images of two adjacent frames; and acquire the photographing moving speed of the target object according to the distance that the target object moves and the time interval.

Further, in an embodiment of the present disclosure, the image processor 52 is further configured to determine at least one key information point in a shot range; acquire a location of the key information point in each of the images of two adjacent frames; and determine, according to the location of the key information point in each of the images of two adjacent frames, the distance that the target object moves between the images of two adjacent frames.

Further, in an embodiment of the present disclosure, the image processor 52 may further be configured to perform smoothing processing on the photographing moving speed.

Optionally, in an embodiment of the present disclosure, when the target object keeps motionless and the image processing apparatus 50 is in a moving state, the image processor 52 uses a moving speed of the apparatus 50 as the photographing moving speed of the target object.

Optionally, in an embodiment of the present disclosure, when the target object and the image processing apparatus 50 are both in a moving state and moving speeds of the target object and the image processing apparatus 50 are inconsistent, the image processor 52 is configured to acquire a distance that the target object moves between images of two adjacent frames; acquire a time interval between the images of two adjacent frames; and acquire the photographing moving speed of the target object according to the distance that the target object moves and the time interval.

When the target object and the image processing apparatus 50 are both in the moving state and the moving speeds of the target object and the image processing apparatus 50 are consistent, the photographing moving speed, which is acquired by the image processor 52, of the target object is zero.

Optionally, in an embodiment of the present disclosure, the image processor 52 is configured to determine, according to the luminance of the current photographing environment and the moving speed of the target object, the exposure parameter by searching a preset exposure parameter table using the memory 53; and determine the gain parameter according to the exposure parameter.

The image processor 52 may be a central processing unit (CPU), or an application specific integrated circuit (ASIC), or one or more integrated circuits configured to implement this embodiment of the present disclosure.

It should be noted that, in addition to the foregoing functions, the foregoing image processor 52 may further be configured to execute other processes in the foregoing method embodiment, and details are not described herein.

It should be further noted that, for division of functional units in the image processor 52, reference may be made to the foregoing embodiment of the image processing apparatus, and details are not described herein.

Correspondingly, this embodiment of the present disclosure further provides a terminal, where the terminal includes the image processing apparatus described in any embodiment in the embodiments of the image processing apparatus described above.

For example, the terminal provided in this embodiment of the present disclosure may be any kind of device that has a photographing function, such as a mobile phone, a tablet computer, a personal digital assistant, or a personal computer.

### Embodiment 4

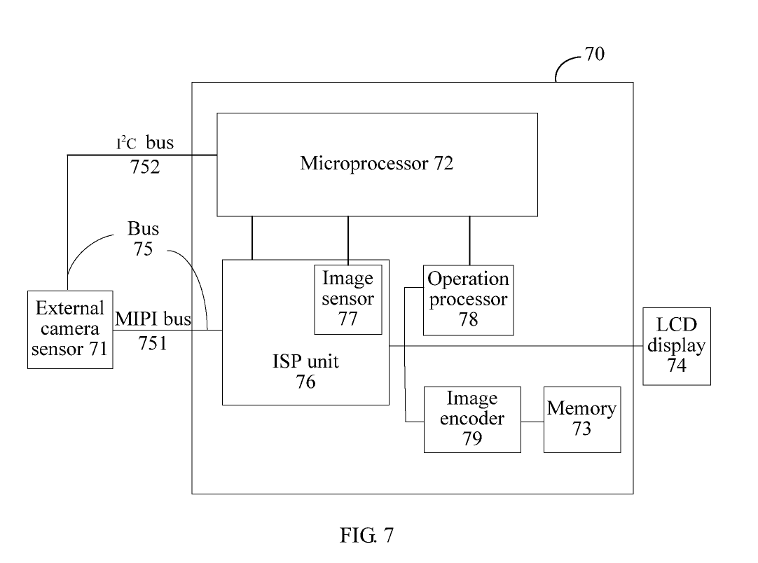

FIG. 7 is a structural block diagram of a part of a mobile phone 70 that is related to a terminal provided in this embodiment of the present disclosure. As shown in FIG. 7, the mobile phone 70 includes modules such as an external camera sensor 71, a microprocessor 72, a memory 73, a liquid crystal display (LCD) 74, a bus 75, an image signal processor (ISP) unit 76, an image sensor 77, an operation processor 78, and an image encoder 79.

The bus 75 includes a mobile industry processor interface (MIPI) bus 751 and an I²C (Inter-Integrated Circuit) bus 752.

A person skilled in the art may understand that a structure of the mobile phone shown in FIG. 7 does not constitute a limitation to the mobile phone, and the mobile phone may include more components or fewer components than those shown in the FIG. 7, or some components may be combined, or different component deployment may be used.

Composition components of the mobile phone 70 are introduced in the following with reference to FIG. 7.

In a preview stage, the external camera sensor 71 may be configured to collect an image, and a collected image of each frame is sent to the ISP unit 76 in the microprocessor 72 through the MIPI bus 751.

The operation processor 78 is configured to determine a photographing moving speed of a target object, and send an obtained result of the photographing moving speed to the microprocessor 72; and at the same time, the ISP unit 76 also sends luminance, which is acquired by a light sensor, of a current photographing environment to the microprocessor 72. In this way, the microprocessor 72 determines, according to the photographing moving speed of the target object and the luminance of the current photographing environment, an exposure parameter and a gain parameter that are required in a photographing stage.

In the photographing stage, in one aspect, the microprocessor 72 sends, through the bus 752, the exposure parameter obtained according to the previous preview stage to the external camera sensor 71 for setting, so that the ISP unit 76 can collect the image according to the exposure parameter; and in another aspect, the microprocessor 72 sends the gain parameter to an ISP unit for setting, so that the ISP unit 76 can perform luminance processing on the collected image according to the gain parameter.

The image obtained after the luminance processing is sent to the image encoder 79 for image compression, and the memory 73 stores the image, or the image is displayed using the LCD 74. The specific method in Embodiment 1 may be implemented by the mobile phone 70, and details are not described herein.

Although not shown in the figure, the mobile phone 70 may further include a camera, a Bluetooth module, and the like, which are not described herein.

The embodiments in this specification are all described in a progressive manner, for same or similar parts in the embodiments, reference may be made to these embodiments, and each embodiment focuses on a difference from other embodiments. Especially, an apparatus embodiment is basically similar to a method embodiment, and therefore is described briefly; for related parts, reference may be made to a description of a part in the method embodiment.

It should be noted that the described apparatus embodiment is merely exemplary. The units described as separate parts may or may not be physically separate, and parts displayed as units may or may not be physical units, may be located in one position, or may be distributed on multiple network units. Some or all of the modules may be selected according to actual requirements to achieve the objectives of the solutions of the embodiments. In addition, in the accompanying drawings of the apparatus embodiments provided in the present disclosure, connection relationships between modules indicate that the modules have communication connections with each other, which may be implemented as one or more communications buses or signal cables. A person of ordinary skill in the art may understand and implement the embodiments of the present disclosure without creative efforts.

Based on the description of the foregoing implementation manners, a person skilled in the art may clearly understand that the present disclosure may be implemented by software in addition to necessary universal hardware, or by dedicated hardware, including a dedicated integrated circuit, a dedicated CPU, a dedicated memory, a dedicated component, and the like. Generally, any function that can be performed by a computer program can be easily implemented using corresponding hardware. Moreover, a specific hardware structure used to implement a same function may be of various forms, for example, in a form of an analog circuit, a digital circuit, a dedicated circuit, or the like. However, for the present disclosure, software program implementation is a better implementation manner in most cases. Based on this understanding, the technical solutions of the present disclosure essentially or the part contributing to the prior art may be implemented in a form of a software product. The computer software product is stored in a readable storage medium, such as a floppy disk, a universal serial bus (USB) flash drive, a removable hard disk, a read-only memory (ROM), a RAM, a magnetic disk, or an optical disc of a computer; and includes several instructions for instructing a computer device (which may be a personal computer, a server, a network device, or the like) to perform the methods described in the embodiments of the present disclosure.

The foregoing descriptions are merely specific implementation manners of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. An image processing method, comprising:
acquiring luminance of a current photographing environment and a photographing moving speed of a target object;
determining an exposure parameter and a gain parameter according to the luminance of the current photographing environment and the photographing moving speed of the target object; and
processing an acquired image of the target object according to the exposure parameter and the gain parameter.

2. The method according to claim 1, wherein when the target object moves and an image processing apparatus keeps motionless, the acquiring the photographing moving speed of the target object comprises:
acquiring a distance that the target object moves between images of two adjacent frames;
acquiring a time interval between the images of two adjacent frames; and
acquiring the photographing moving speed of the target object according to the distance that the target object moves and the time interval.

3. The method according to claim 2, wherein the acquiring the distance that the target object moves between images of two adjacent frames comprises:
determining at least one key information point in a shot range;
acquiring a location of the key information point in each of the images of two adjacent frames; and
determining, according to the location of the key information point in each of the images of two adjacent frames, the distance that the target object moves between the images of two adjacent frames.

4. The method according to claim 1, wherein a moving speed of an image processing apparatus is used as the photographing moving speed of the target object when the target object keeps motionless and the image processing apparatus is in a moving state.

5. The method according to claim 1, wherein, when the target object and an image processing apparatus are both in a moving state and moving speeds of the target object and the image processing apparatus are inconsistent, the acquiring the photographing moving speed of the target object comprises:
acquiring a distance that the target object moves between images of two adjacent frames;
acquiring a time interval between the images of two adjacent frames; and
acquiring the photographing moving speed of the target object according to the distance that the target object moves and the time interval, and
wherein, when the target object and the image processing apparatus are both in the moving state and the moving speeds of the target object and the image processing apparatus are consistent, the acquired photographing moving speed of the target object is zero.

6. The method according to claim 1, wherein determining the exposure parameter and the gain parameter according to the luminance of the current photographing environment and the photographing moving speed comprises:
determining, according to the luminance of the current photographing environment and the photographing moving speed of the target object, the exposure parameter by searching a preset exposure parameter table; and
determining the gain parameter according to the exposure parameter.

7. The method according to claim 2, further comprising performing smoothing processing on the photographing moving speed.

8. An image processing apparatus, comprising:
an acquiring unit configured to acquire luminance of a current photographing environment and a photographing moving speed of a target object;
a determining unit configured to determine an exposure parameter and a gain parameter according to the luminance of the current photographing environment and the photographing moving speed of the target object that are acquired by the acquiring unit; and
a processing unit configured to process an acquired image of the target object according to the exposure parameter and the gain parameter that are determined by the determining unit.

9. The apparatus according to claim 8, wherein, when the target object moves and the image processing apparatus keeps motionless, the acquiring unit comprises:
a first acquiring module configured to acquire a distance that the target object moves between images of two adjacent frames;
a second acquiring module configured to acquire a time interval between the images of two adjacent frames; and
a third acquiring module configured to acquire the photographing moving speed of the target object according to the distance that the target object moves and the time interval, wherein the distance that the target object moves is acquired by the first acquiring module and the time interval is acquired by the second acquiring module.

10. The apparatus according to claim 9, wherein the first acquiring module is configured to:
determine at least one key information point in a shot range;
acquire a location of the key information point in each of the images of two adjacent frames; and
determine, according to the location of the key information point in each of the images of two adjacent frames, the distance that the target object moves between the images of two adjacent frames.

11. The apparatus according to claim 8, wherein, when the target object keeps motionless and the image processing apparatus is in a moving state, the acquiring unit uses a moving speed of the apparatus as the photographing moving speed of the target object.

12. The apparatus according to claim 9, wherein, when the target object and the image processing apparatus are both in a moving state and moving speeds of the target object and the image processing apparatus are inconsistent, wherein the first acquiring module is further configured to acquire a distance that the target object moves between images of two adjacent frames, wherein the second acquiring module is further configured to acquire a time interval between the images of two adjacent frames, wherein the third acquiring module is further configured to acquire the photographing moving speed of the target object according to the distance that the target object moves and the time interval, and wherein, when the target object and the image processing apparatus are both in the moving state and the moving speeds of the target object and the image processing apparatus are consistent, the photographing moving speed, which is acquired by the third acquiring module, of the target object is zero.

13. The apparatus according to claim 8, wherein the determining unit comprises:
a first parameter determining module configured to determine, according to the luminance of the current photographing environment and the photographing moving speed of the target object, the exposure parameter by searching a preset exposure parameter table; and
a second parameter determining module configured to determine the gain parameter according to the exposure parameter.

14. The apparatus according to claim 9, wherein the processing unit is further configured to perform smoothing processing on the photographing moving speed.

15. A terminal comprising an image processing apparatus, wherein the image processing apparatus comprises:
an acquiring unit configured to acquire luminance of a current photographing environment and a photographing moving speed of a target object;
a determining unit configured to determine an exposure parameter and a gain parameter according to the luminance of the current photographing environment and the photographing moving speed of the target object that are acquired by the acquiring unit; and
a processing unit configured to process an acquired image of the target object according to the exposure parameter and the gain parameter that are determined by the determining unit.
